(19) United States
(12) Patent Application Publication
(10) Pub. No.: US 2015/0342130 A1
(43) Pub. Date: Dec. 3, 2015

(54) ROOT GUIDE FOR LENGTHENING ROOTS OF A PLANT IN A POT

(71) Applicant: Mark Stuart PRICHARD, (US)

(72) Inventor: Mark Stuart PRICHARD, Melbourne (AU)

(21) Appl. No.: 14/759,608

(22) PCT Filed: Dec. 3, 2013
(86) PCT No.: PCT/AU2013/001399

§ 371 Date: Jul. 7, 2015

(30) Foreign Application Priority Data
Jan. 8, 2013 (AU) 2013900054

(51) Int. Cl. A01G 9/02; A01G 1/00

(52) U.S. Cl. CPC A01G 9/02; A01G 1/001

(57) ABSTRACT

A root guide for lengthening roots of a plant in a pot can include a track spiralling radially from a central axis. The track can spiral for at least two revolutions. In use, roots of the potted plant can spiral down the soil covered track as the plant grows.

### TECHNICAL FIELD OF THE INVENTION

The present invention relates to a root guide for lengthening roots of a plant in a pot.

### BACKGROUND OF THE INVENTION

Plants will typically send out roots underground until they meet resistance from a surface. When resistance occurs, that blocks the outward and downward growth of the roots, the growth of the plant is impeded. For potted plants, this occurs when the roots grow out a sufficient distance to meet the walls and base of the pot. The plant then becomes “pot bound” with roots winding back on themselves. As a consequence, a considerable percentage of the roots of a pot plants is usually cut away before planting. This impedes the growth of the plant for a considerable time after planting. An ideal ratio of the roots to the above ground part of most plants is about 1 to 1, for example.

The above-described difficulties can be avoided by growing plants in pots that are much larger than would typically be used. However, this may not be an efficient solution when growing plants in a crowded space, such as a plant nursery. The pot plant is also heavier to move and requires more soil. Further, growing a plant in such an oversized pot may shift the focus from the plant to the pot itself, creating an unbalanced, less aesthetically pleasing look.

Japanese Patent Application Number 11318217 (JP 11318217) attempts to solve one or more of the above described difficulties. With reference to FIGS. 1a to 1c, JP 11318217 provides a pot having a spiral protrusion (3) which is formed on the inner circumference (2) of the vessel main body (1) as a guide for guiding root (6) of a plant. The root (6) of the plant is grown along the spiral protrusion (3). When the soil is filled in the vessel main body (1), a space free from the soil (4) is spirally formed around the spiral protrusion (3) to enable elongation of the root (6) along the space and the uniform growth of the root (6) over a wide range in the soil (4).

JP 11318217 may go some way to providing a useful solution to one or more of the above described problems. However, the spiral protrusion (3) which is formed on the inner circumference (2) of the vessel main body (1) may not provide a sufficient platform to direct the majority of the roots in a manner that increases the overall root length of the plant and inhibits roots winding back on themselves. Further, JP 11318217 may not provide a platform to adequately control a distribution of water and/or fertilizer to the roots of the plant. Finally, JP 11318217 may not provide a mechanism that assists in removal of the plant from the pot. Rather, it appears that the fixed protrusion of JP 11318217 may hinder this process.

It is generally desirable to overcome or ameliorate one or more of the above mentioned difficulties, or at least provide a useful alternative.

### SUMMARY OF THE INVENTION

In accordance with the invention, there is provided a root guide for lengthening roots of a plant in a pot, including a track spiralling radially from a central axis, wherein the track spirals for at least one revolution, and, in use, roots of the potted plant spiral down the soil covered track as the plant grows.

Preferably, the track spirals radially around a central core.

Preferably, a radius of the track is substantially a radius of a base section of the pot.

Preferably, a length of the track is greater than a height of the pot.

Preferably, a circumference of each revolution of the track is greater than a circumference of a base section of the pot.

In accordance with the invention, there is also provided an elongate tube of flexible breathable material adapted to be filled with soil to act as a conduit for roots of a plant to grow along.

Preferably, the tube includes a barrier extending along one side of the tube for inhibiting growth of roots therethrough. The barrier is preferably an upper barrier for inhibiting upper roots in a section of the tube growing down on roots in a lower section of the tube when the tube is arranged in a spiral. The barrier is preferably plastic.

In accordance with the invention, there is also provided, in combination, the above described tube and the above described root guide.

In accordance with the invention, there is also provided, in combination, a pot; the above described tube; and the above-described root guide.

In accordance with the invention, there is also provided, in combination, a pot and the above described root guide.

In accordance with the invention, there is also provided a method of potting a plant in a pot, including the steps of:
(a) putting soil in the above-mentioned tube;
(b) coiling the tube into a pot; and
(c) planting one or more seeds or seedlings in the soil in an upper section of the tube.

The method preferably includes the step of burying the coiled tube in the soil in the pot.

### BRIEF DESCRIPTION OF THE DRAWINGS

Preferred embodiments of the present invention are hereafter described, by way of non-limiting example only, with reference to the accompanying drawing in which:

FIGS. 1a to 1c are views of prior art pots;

FIG. 2a is a side view of a pot plant including a root guide;

FIG. 2b is a section view of the pot plant shown in FIG. 2a through the line Y-Y;

FIG. 3a is a side perspective view of the root guide shown in FIGS. 2a and 2b;

FIG. 3b is a top view of the root guide shown in FIG. 3a;

FIGS. 3c and 3d are side perspective views of preferred embodiments of the root guide shown in FIGS. 2a and 2b; FIG. 4a is a side view of the pot and root guide shown in FIGS. 2a and 2b; FIG. 4b is a top view of the pot and root guide shown in FIG. 4a;

FIG. 4c is a section view of the pot and root guide shown in FIG. 4a through the line X-X;

FIGS. 4d to 4f are other views of the pot and root guide shown in FIG. 4c shown in different conditions of use;

FIG. 5 is a side view of an elongate tube wrapped around the guide shown in FIGS. 3a and 3b;

FIG. 6a is a side view of a pot including the tube and guide shown in FIG. 5;

FIG. 6b is a section view of the pot shown in FIG. 6a through the line Z-Z;

FIG. 6c is a top view of the pot shown in FIG. 6a; and

FIGS. 6d to 6g are views of the pot shown in FIG. 5c in different conditions of use.

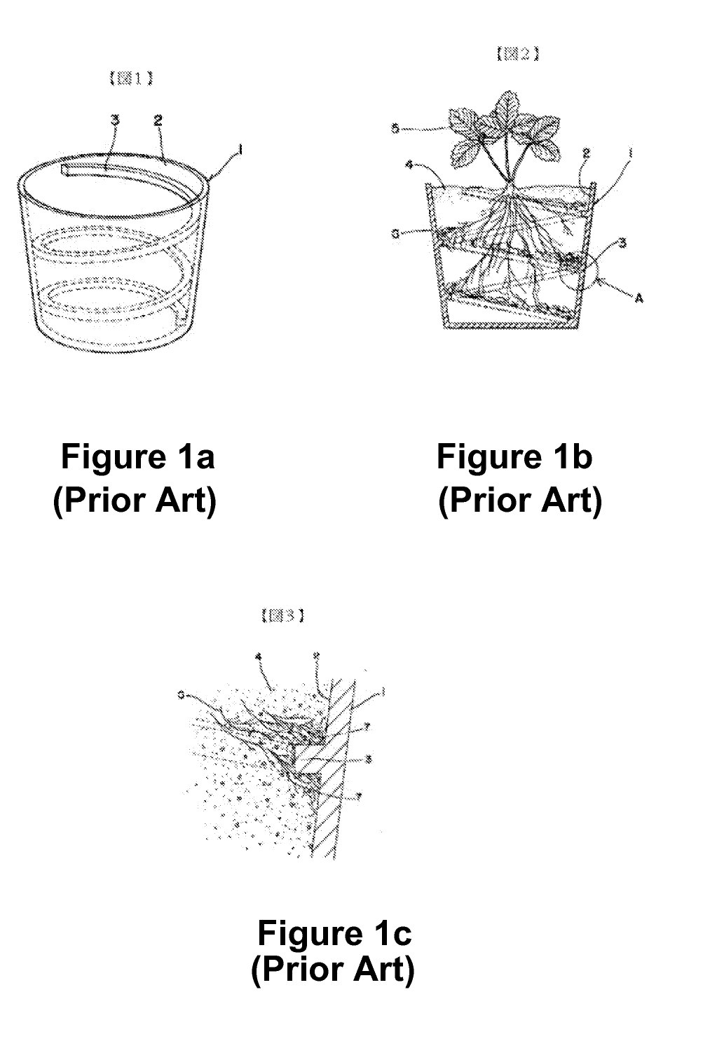

### DETAILED DESCRIPTION OF PREFERRED EMBODIMENTS OF THE INVENTION

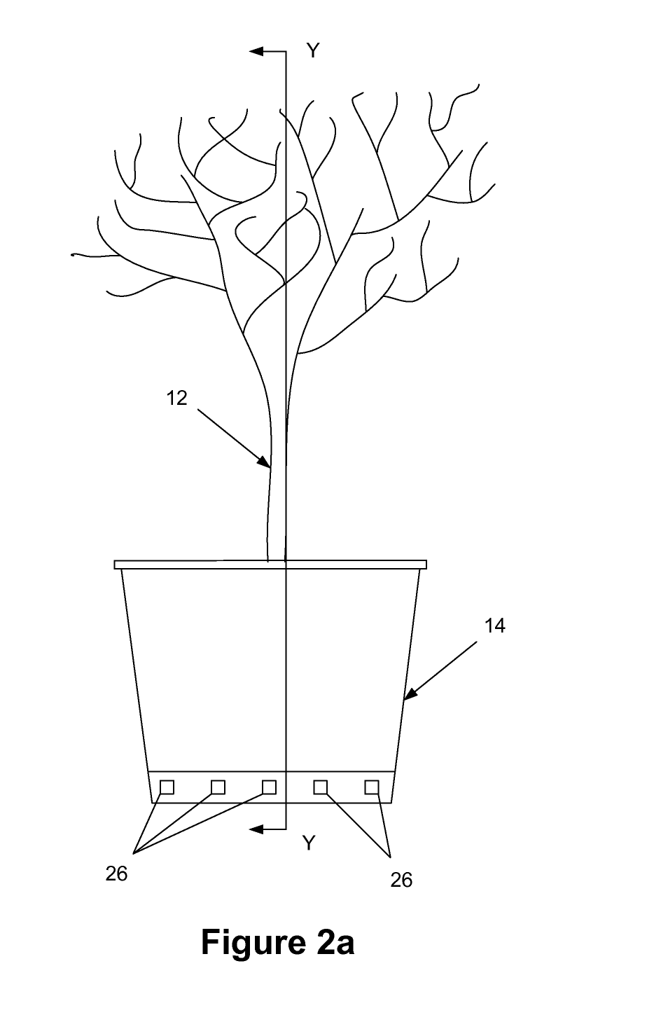

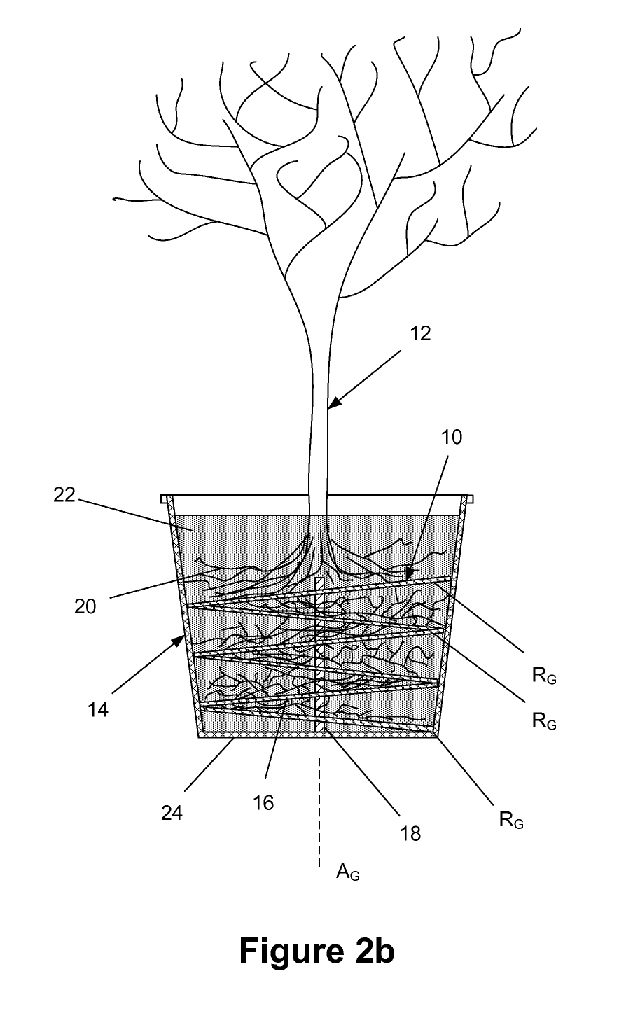

The root guide 10 for lengthening roots 20 of a plant 12 in a pot 14 in the manner shown in FIGS. 2a and 2b. The root guide 10 includes a track 16 spiralling radially from a central axis “A_{G}”. The roots 20 of the plant 12 spiral down the soil 22 covered track 16 as the plant grows. The guide 10 thereby directs the roots 20 down the track 16 as the plant 12 grows downwards into the pot 14.

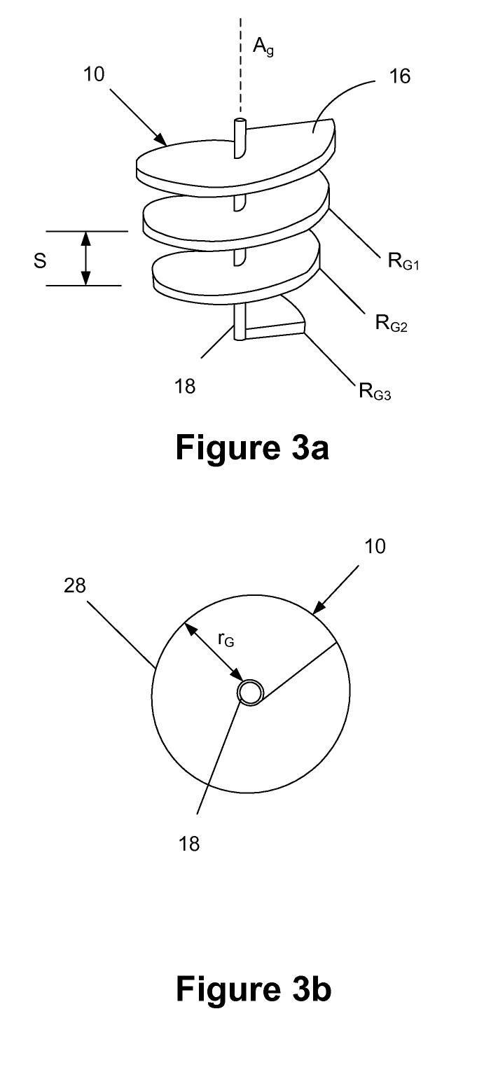

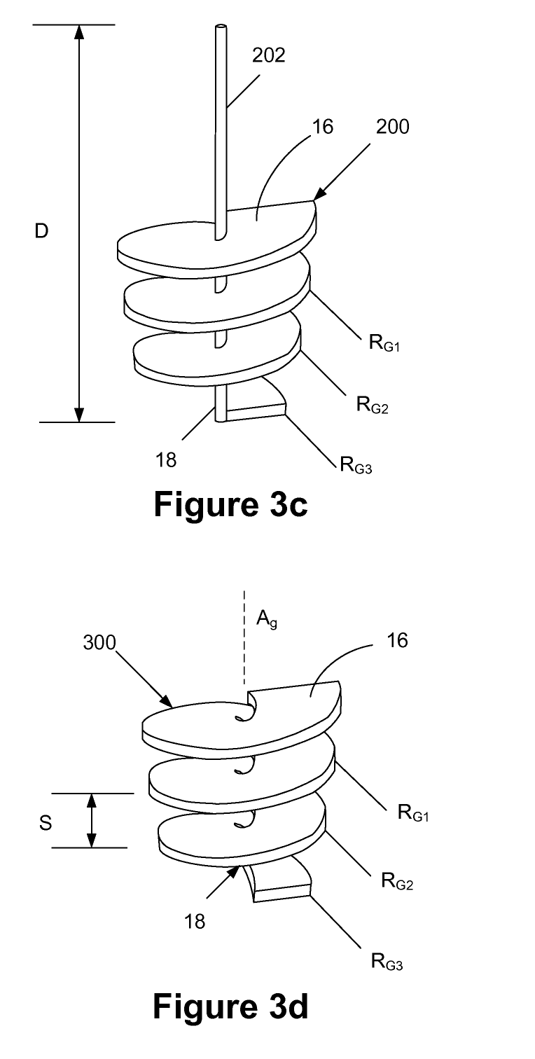

In the example shown in FIGS. 3a and 3b, the track 16 spirals radially around a central core 18. Alternatively, the track 16 is formed as a single unit that spirals about the axis A_{G} only.

Further, in the example shown, the track 16 spirals three revolutions R_{G} around the axis A_{G}. Alternatively, the track 16 spirals any suitable number of revolutions R_{G} around the axis A_{G}. For example, the track 16 can include one, two three or four revolutions R_{G}.

The guide 10 is adapted to be seated in the pot 14 when the pot is substantially filled with soil 22 so that the track is substantially covered with soil 22. For example, the guide 10 is adapted to be screwed into the pot 14 when the pot is substantially filled with soil 22 so that the track 16 is substantially covered with soil 22.

The pot 14 is preferably any currently available pot 14 that has a height H_{P} and a base section 24 having a width of W_{P}. For example, the pot 14 is a plastic pot having a plurality of slots 26 formed in the wall of the base section 24. Alternatively, the pot 14 could be terracotta or any other pot 14 suitable for growing plants.

The guide 10 is shaped to be seated in a base section 24 of the pot 14. In the embodiment shown in FIGS. 3a and 3b, the diameter D_{G} increases with each revolution R_{G} above the base section 24 of the pot 14. In doing so, an outer peripheral edge of the track follows and/or abuts the conical shape of walls 30 of the pot 14. Alternatively, the diameter D_{G} of each revolution, R_{G}, of the track 16 is substantially the same. In this alternative embodiment, the diameter D_{G} of each revolution of the track 16 of the guide 10 is slightly less than the width W_{P} of the base section 24 of the pot 14. The height H_{G} of the guide 10 is preferably two thirds of the height H_{P} of the pot 14. Alternatively, height H_{G} is any other suitable height that is less than the height H_{P} of the pot. This leaves a gap of height H_{A} between the top of the guide 10 and the top of the pot 14. This gap is substantially filled with dirt when the guide 10 is buried under soil 22 in the pot 14.

The space “S” between adjacent revolutions R_{G} of the track 16 of the guide 10 determines the slope of the track 16. For example, if the space “S” is relatively small, then the slope of the track will be relatively small. Conversely, if the space “S” is relatively large, than the slope of the track 16 will be relatively large. Amongst other things, the slope of the track controls the rate of flow of water and/or fertilizer down the guide 10. For example, the slower that the water travels down the guide 10, the less water needed to water the plant 12. As such, the guide 10 can be designed to suit the needs of any given plant variety and climate.

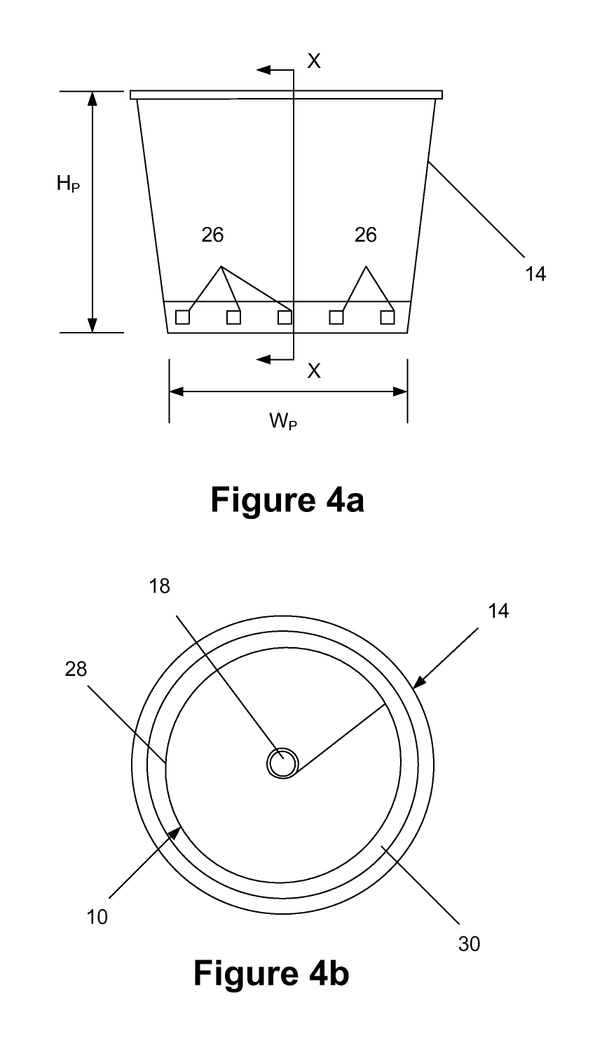

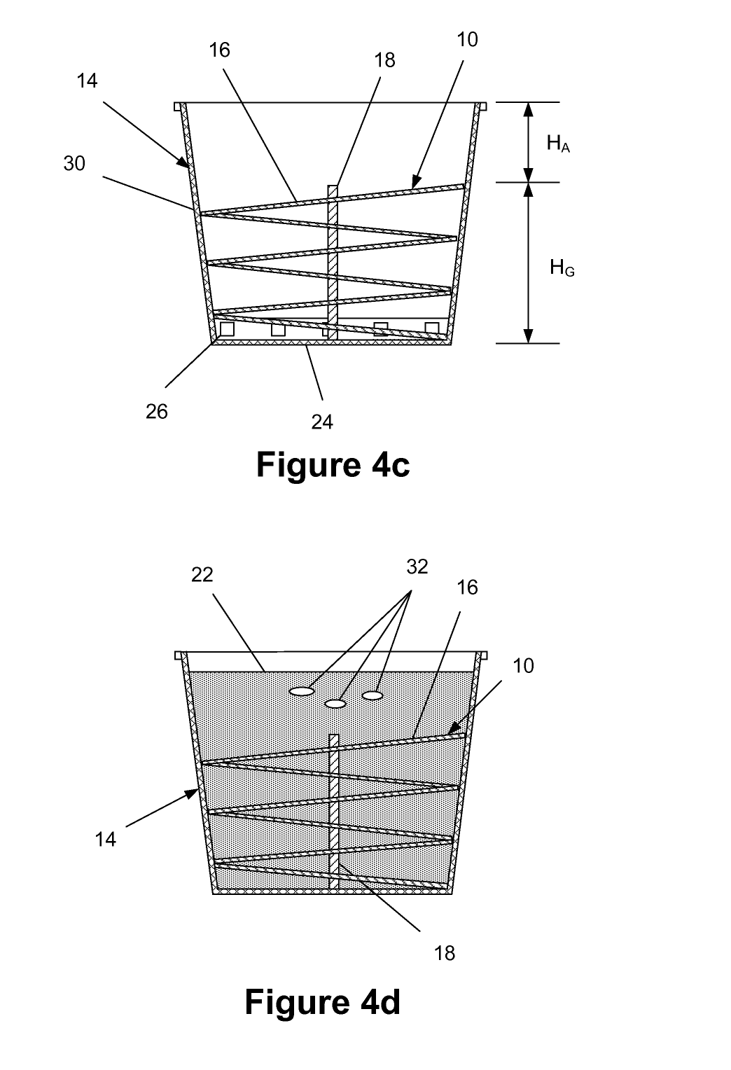

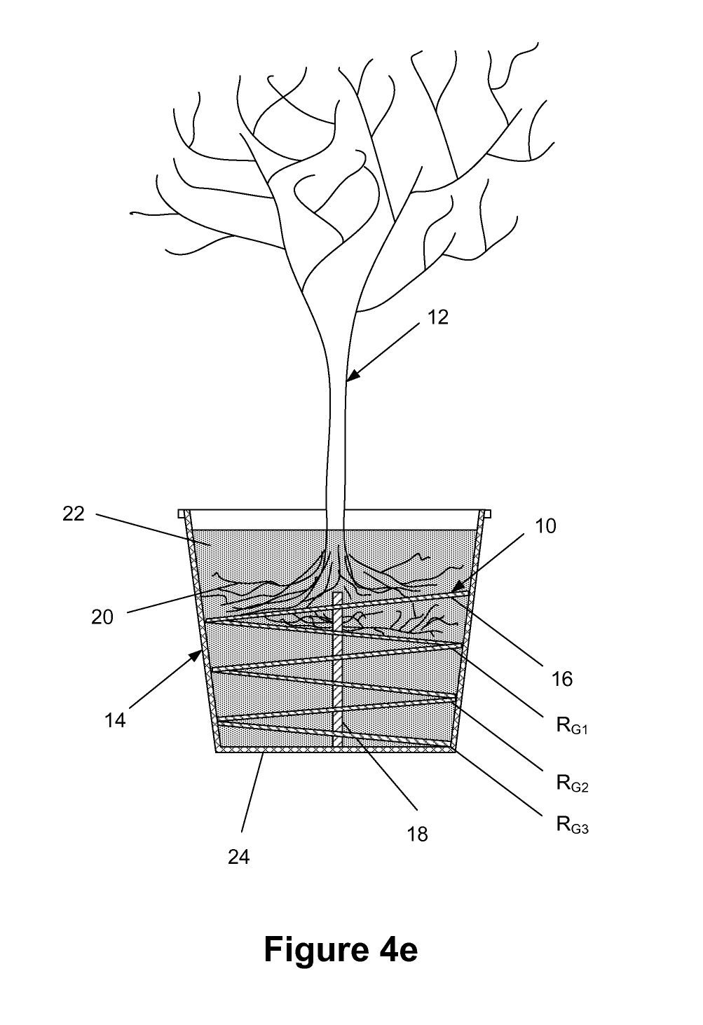

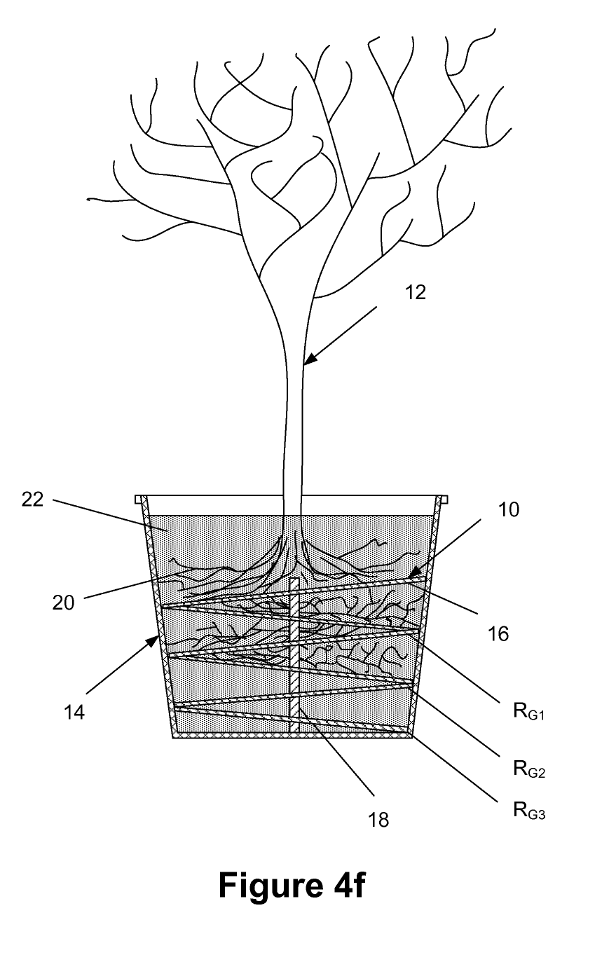

In use, the guide 10 is preferably seated in the pot 14 in the manner shown in FIG. 4c and soil 22 is then filled into the pot in the manner shown in FIG. 4d such that the track 16 of the guide is generally buried in the soil 22. The guide 10 is preferably adapted to be buried in the pot 14 by screwing the track 16 into the soil 22 such that the track is substantially covered with soil 22.

A length of the track 16 is preferably greater than a height H_{P} of the pot 14. In the example shown in FIGS. 3a and 3b, the length of an outer peripheral edge 28 of the track 16 is R_{G}*(2*π*r_{G}), where R_{G} is a number of revolutions of the track, it is a constant, and r_{G} is a radius of the track.

An upper side of the track 16 preferably includes a plurality of dimples (not shown). The dimples advantageously change a rate of flow of water down the track 16.

An upper side of the track 16 also preferably includes one or more runnels (not shown) for channelling water down the track 16.

The guide 10 is preferably made of plastic. Alternatively, the guide 10 made of metal or any other suitable material.

As shown in FIGS. 4d to 4f, when seeds 32 are planted in the soil 22 of pot 14 including a root guide 10 buried therein, the roots 20 grow down into the pot 14 by following the spiral surface of the track 16. A similar result would also be achieved if a small plant 12 was planted in the soil 22.

The guide 10 also acts as a stabiliser for plants 12. It provides stability for plants 12 which remain in the pot 10 (decorative indoor pot plants etc). The guide 10 provides anchor points.

By directing the roots 20 of plants 12 down the track of the guide 10, a far greater length for the roots 20 is achievable before they are impeded. Further, the flow of water down through a pot plant 14 fitted with the guide 10 is slowed resulting in savings on the amount of water and the frequency with which watering has to occur. Further evaporation rates from soil in pots containing guide 10 are lower than ordinary pots, resulting in savings on the amount of water and the frequency with which watering has to occur.

When given the opportunity, the roots will rest on gently sloped track 16 of the guide 10 rather than the sides of the plant. This provides a “mesh” of undamaged roots 20 ready for planting. There is consequently little or less need for pruning the roots before planting. A major advantage is that roots do not get “potbound” to nearly the same degree as would be the case if the plant was potted without the guide 10.

When planting occurs, the roots 20 are much longer. Therefore they can be planted to a greater depth. As such, plants 12 are able to reach the water table more quickly and “establish” themselves more quickly.

The alternative embodiment of the guide 200 shown in FIG. 3c includes a many of the features of the guide 10. Like parts are marked with like reference numerals. The central core 18 of the guide 200 includes an elongate shaft 202 that extends vertically out of the pot (not shown). The height “D” of the central core 18 (including the shaft 202) is preferably less than 100 cm. The shaft 202 can be used as a stake for supporting a plant (not shown). Further, the shaft 202 can be used as a handle to extract the guide from the pot.

The alternative embodiment of the guide 300 shown in FIG. 3d includes a many of the features of the guide 10. Like parts are marked with like reference numerals. The track 16 spirals around the central core 18 having an axis A_{g}.

The spirals of the guide 10 may be either be either a clockwise or counter-clockwise.

### Tube 100

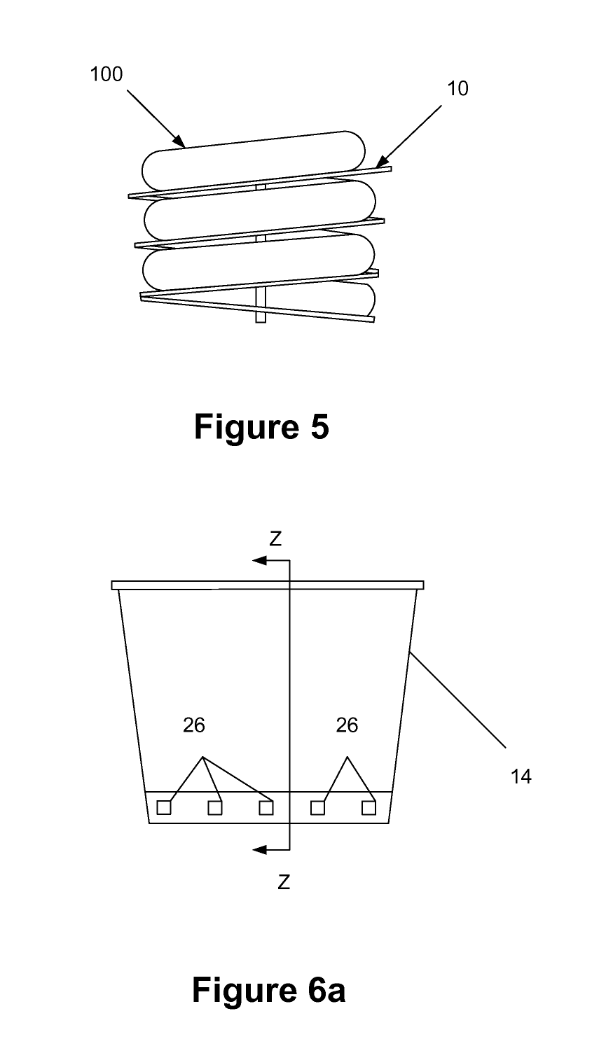

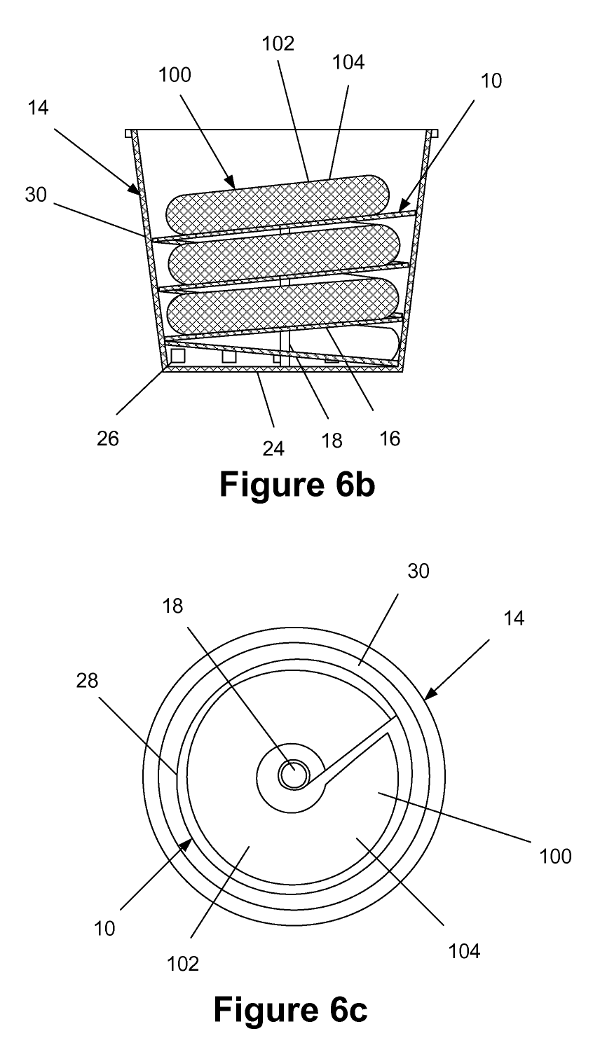

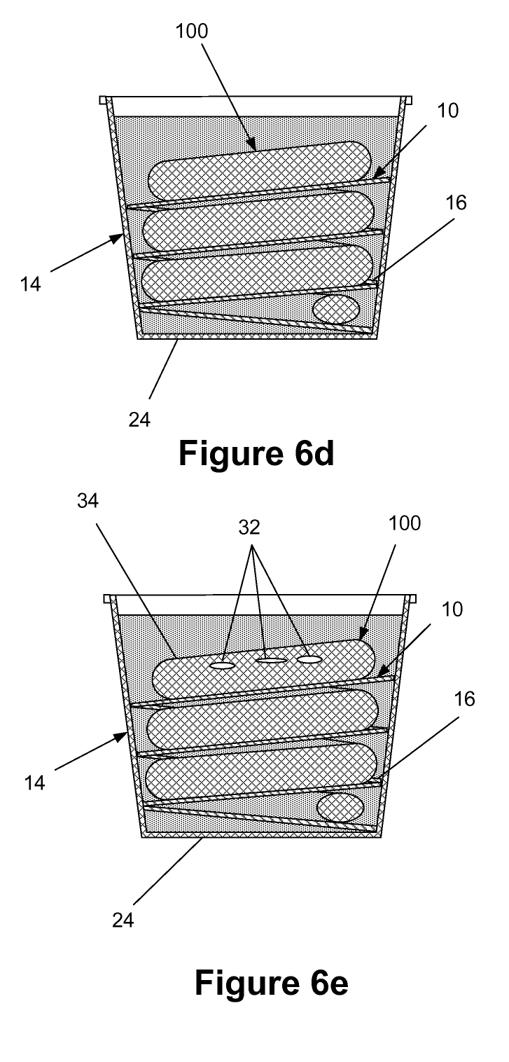

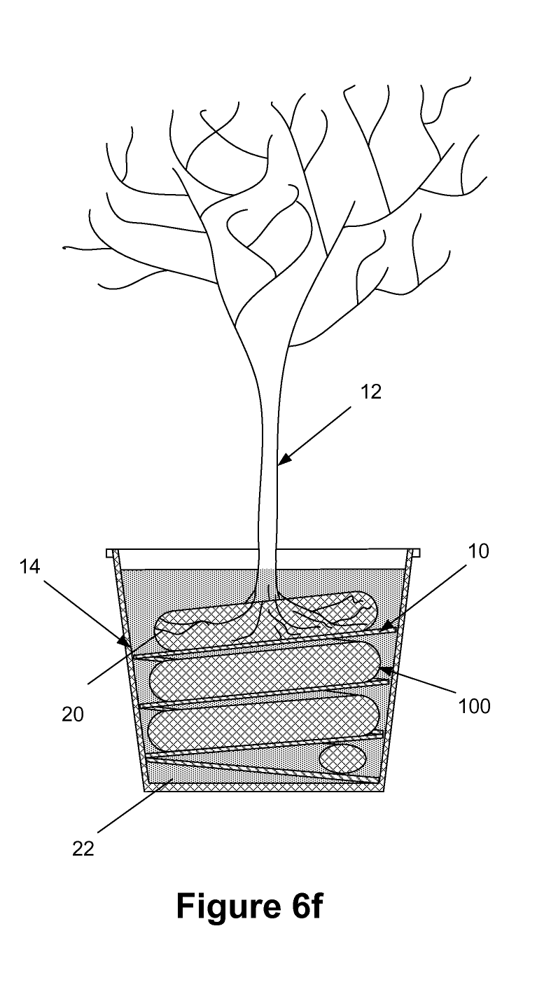

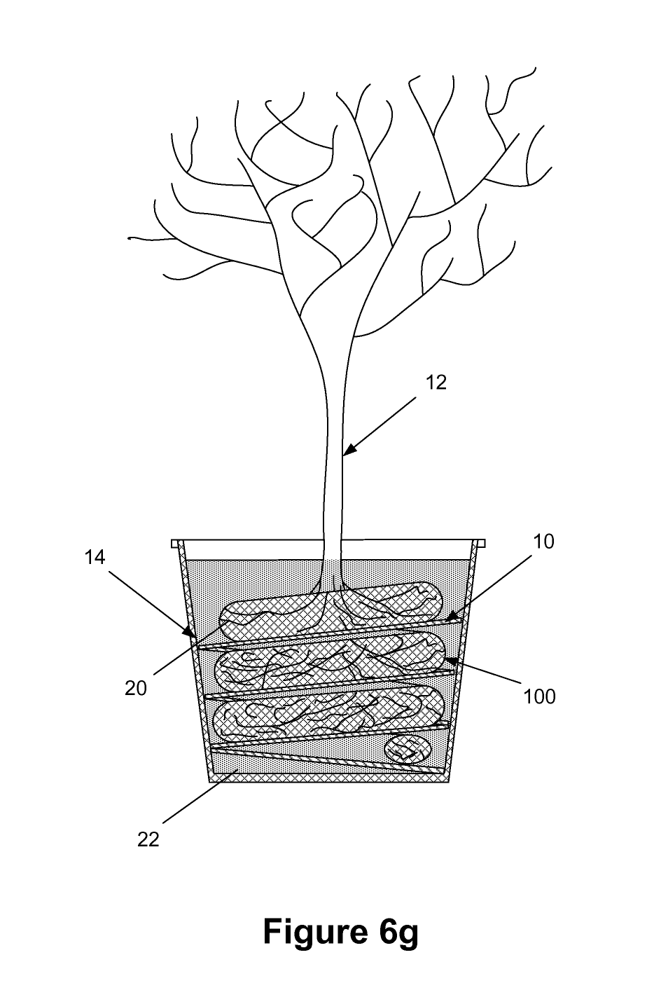

A difficulty with the guide 10 may be encountered when burying the guide in the soil. For example, getting earth 22 quickly and effectively into the track 16 space may be difficult and/or time consuming. The tube 100 show in FIGS. 5 to 6g can be used to assist in this process. In addition all the earth from the pot is buried with the roots, thus supplying the roots with nutrients and ensuring there is maximum use of potting mix soil.

The elongate tube 100 is made of flexible breathable material adapted to be filled with soil 22 and to act as a conduit for roots 20 of a plant 12. As particularly shown in FIG. 5, the soil filled tube 100 can be wrapped around the guide 10 so that it is neatly seated on the track 16. The guide 10 and the tube 100 can then be seated in the pot 14, in the manner shown in FIGS. 6a to 6c, and then buried with soil 22 in the manner shown in FIG. 6d.

Preferably, before the tube is buried, a first section 34 of the tube 100 is cut and laid open. Seeds 32 are then placed in the laid open section 34 of the tube 100. Finally, the tube 100 is buried. The roots 20 of the plant 12 grow into the tub 100 and follow it down the spiral track 16 in the manner shown in FIGS. 6f and 6g. A similar result would also be achieved is a small plant 12 was planted in the open section 34 of the tube 100.

The tube 100 includes a barrier 102 extending along one side 104 for inhibiting growth of roots 20 therethrough. The barrier 102 is preferably an upper barrier for inhibiting upper roots 20 in a section of the tube 100 growing down on roots in a lower section of the tube 100 when the tube 100 is arranged in a spiral. The barrier 102 is preferably plastic, although any other suitable material could be used. The tube 100 is preferably made of an elasticised mesh such as stocking type material, cotton, or any other suitable material. The tube 100 is preferably biodegradable. The tube 100 can be used independently of the guide 10. For example, the tube 100 can be use to grow a plant by performing the steps of:

1. filling the tube 100 with potting mix 22;
2. coiling the tube 100 into a pot;
3. planting seeds 32 in an upper section of the coiled tube 100; and
4. filling the pot with soil 22.

Alternatively, seedlings can be planted in upper section of coiled tube 100.

### Extraction

A pot plant 14 fitted with the guide 10 has part of the guide 10 touching the bottom of the pot 10. Extraction of the plant 12 and guide 10 can be achieved/assisted by inserting an “L” shaped device, (similar to a large tent peg) through one of the holes 26 at the bottom of the pot 14. This “L” shaped device helps alleviate the common problem of damaging plants 12 when trying to remove them from the pot 12.

Many modifications will be apparent to those skilled in the art without departing from the scope of the present invention

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

1. A root guide for lengthening roots of a plant in a pot, the root guide comprising:
a track spiralling that spirals radially from a central axis,
wherein the track spirals for at least one revolution, and, in use, roots of the plant spiral down soil that covers the track as the plant grows.

2. The root guide of claim 1, wherein the track spirals radially around a central core.

3. The root guide of claim 1, wherein a radius of the track is substantially a radius of a base section of the pot.

4. The root guide of claim 1, wherein a length of the track is greater than a height of the pot.

5. The root guide of claim 1, wherein a circumference of each revolution of the track is greater than a circumference of a base section of the pot.

6. The root guide of claim 1, wherein a length of the track is greater than R*(2*π*r), where R is a number of revolutions of the track, π is a constant, and r is a radius of the track.

7. The root guide of claim 1, wherein the root guide is adapted to be seated in the pot when the pot is substantially filled with the soil, such that the track is substantially covered with the soil.

8. The root guide of claim 1, wherein the guide is adapted to be buried in the pot by screwing the track into the soil, such that the track is substantially covered with the soil.

9. The root guide of claim 1, wherein the root guide is shaped to be seated in a base section of the pot.

10. The root guide claimed of claim 1, wherein the root guide occupies two thirds of the pot.

11. The root guide of claim 1, wherein the at least one revolution comprises at least three revolutions around the axis.

12. The root guide of claim 1, wherein a slope of the track controls, at least in part, a rate of water flow down the track.

13. The root guide of claim 1, wherein an upper side of the track includes a plurality of dimples.

14. The root guide of claim 13, wherein the dimples control, at least in part, a rate of flow of water down the track.

15. The root guide of claim 1, wherein an upper side of the track includes one or more runnels that channel water down the track.

16. The root guide of claim 1, wherein the at least one revolution comprises three revolutions.

17. An elongate tube, comprising:
a flexible breathable material adapted to be filled with soil,
wherein the elongate tube acts as a conduit for roots of a plant to grow along.

18. The elongate tube of claim 17, wherein one side of the elongate tube includes a barrier extending along its length, and wherein the barrier inhibits growth of the roots therethrough.

19. The elongate tube of claim 18, wherein the barrier is an upper barrier that inhibits the roots in an upper section of the elongate tube from growing down on the roots in a lower section of the elongate tube when the elongate tube is arranged in a spiral.

20. The elongate tube of claim 19, wherein the barrier is plastic.

21. The elongate tube of claim 17, wherein the material comprises a stocking material.

22. A combination, comprising:
a root guide including a track that spirals radially from a central axis; and
an elongate tube including a flexible breathable material adapted to be filled with soil,
wherein the track spirals for at least one revolution and, in use, roots of a plant spiral down the soil that covers the track as the plant grows, and
wherein the elongate tube acts as a conduit for the roots to grow along.

23. The combination of claim 24, further comprising an elongate tube including a flexible breathable material adapted to be filled with the soil, and wherein the elongate tube acts as a conduit for the roots to grow along.

24. A combination, comprising:
a pot; and
a root guide in the pot, the root guide including a track that spirals radially from a central axis,
wherein the track spirals for at least one revolution and, in use, roots of a plant spiral down soil that covers the track as the plant grows.

25. A method of potting a plant in a pot, the method including the steps of:
(a) putting soil in an elongate tube including a flexible breathable material adapted to be filled with the soil, the elongate tube acting as a conduit for roots to grow along;
(b) coiling the tube into the pot; and
(c) planting one or more seeds or seedlings in the soil in an upper section of the tube.

26. The method of claim 25, including the step of burying the coiled tube in the soil in the pot.
